(19) United States
(12) Patent Application Publication
(10) Pub. No.: US 2005/0219597 A1
(43) Pub. Date: Oct. 6, 2005

(54) Printing machine allowing modification of operation screen configuration to configuration suitable for user's work mode and method of controlling the same

(76) Inventors: Masami Nojiri, Ibaraki-ken (JP); Hideo Sekizawa, Ibaraki-ken (JP); Takayuki Tokozume, Ibaraki-ken (JP)

Correspondence Address: NATH & ASSOCIATES, PLLC;Sixth Floor, 1030 15th Street, Washington, DC, 20005, US

(21) Appl. No.: 11/092,712

(22) Filed: Mar. 30, 2005

(30) Foreign Application Priority Data
Apr. 1, 2004 (JP) JP2004-109281

(51) Int. Cl. G06F 15/00; H04N 11/20

(52) U.S. Cl. 358/1.13; 358/1.16

(57) ABSTRACT

A work mode information storage unit previously stores a work mode table in which information on operation buttons corresponding to functions frequently used are described according to each work mode. In response to a user operating an input device and selecting the work mode, a CPU retrieves information on operation buttons corresponding to the selected work mode. The CPU then organizes an operation screen according to the retrieved information on the operation buttons and displays the operation screen on the display unit. The user can therefore easily modify the configuration of the operation screen to a configuration suitable for the work mode selected by the user.

### BACKGROUND OF THE INVENTION

The present invention relates to a printing machine including a display unit on which an operation screen is displayed and capable of being instructed to execute a function assigned to an operation button on the operation screen by selection and operation of the operation button and relates to a method of controlling the same. More specifically, the present invention relates to a technology allowing the configuration of the operation screen to be modified (customized) into a configuration suitable for user's work mode.

In recent years, as the number of functions of a printing machine increases, more operation buttons are displayed on operation screens. Accordingly, it takes a longer time for a user to operate a desired operation button, and the degradation of operationability of the printing machine has become an issue. From such a background, as disclosed in the Japanese Patent Laid-Open publications No. Hei 8-129469 and No. 2001-237068, a recent printing machine includes an operation screen customization function allowing modification of the configuration of the operation screen to a configuration suitable for a user by means of displaying a frequently-used operation button on a top screen or a menu screen of the operation screen.

However, according to the conventional operation screen customization function, the user has to set positions of the operation buttons one by one while thinking which of a plurality of screens constituting the operation screen, such as the top screen and the menu screen, each operation button is arranged on. Accordingly, the modification of the configuration of the operation screen to the desired configuration requires a lot of time.

Moreover, the customization of the operation screens is difficult for a user unfamiliar with operations of the printing machine to execute. According to the conventional printing machine, therefore, in some cases, the user uses the printing machine with the configuration of the operation screen which does not fit to user's work mode, and the printing work is not efficiently performed.

The present invention is made for solving the aforementioned problem, and an object of the invention is to provide a printing machine in which the configuration of the operation screens can be modified to a configuration suitable for user's work mode and the method of controlling the same.

### SUMMARY OF THE INVENTION

In order to solve the aforementioned problem, a printing machine according to the present invention includes a display unit on which an operation screen is displayed and can be instructed to execute of a function assigned to an operation button on the operation screen by selection and operation of the operation button. The printing machine includes: a storage unit, and a selection unit, and a controller. The storage unit stores information on the operation button arranged on the operation screen for each of a plurality of work modes. The selection unit allows a user to select a main work mode in which the printing machine is mainly used from among the plurality of work modes. The controller, in response to the main work mode being selected by the selection unit, reads information on the operation button corresponding to the main work mode from the storage unit, organizes the operation screen according to the information on the operation button, and displays the operation screen organized on the display unit.

A method of controlling a printing machine according to the present invention is a method of controlling a printing machine which includes a display unit on which an operation screen is displayed and can be instructed to execute a function assigned to an operation button on the operation screen by selection and operation of the operation button. The controlling method includes the steps of: a user selecting a main work mode in which the printing machine is mainly used from among a plurality of work modes; and in response to the user selecting the main work mode, reading information on the operation button corresponding to the main work mode from a storage unit which stores information on the operation button arranged on the operation screen for each of a plurality of work modes, organizing the operation screen according to the information on the operation button, and displaying the operation screen on the display unit.

In the printing machine according to the present invention and the method of controlling the same, the configuration of the operation screen is automatically changed to the configuration according to the selected work mode in response to the user selecting a desired work mode, and the user can easily modify the configuration of the operation screen to the configuration suitable for the work mode selected by the user.

### BRIEF DESCRIPTION OF THE DRAWINGS

FIG. 1 is a block diagram showing a configuration of a stencil printing machine as an embodiment of the present invention.

FIG. 2 is an image view showing a POP area of an operation screen displayed on a display unit shown in FIG. 1

FIG. 3 is an image view showing a favorite area of the operation screen displayed on the display unit shown in FIG. 1.

FIG. 4 is a view showing a work mode table stored in a work mode information storage unit shown in FIG. 1.

FIG. 5 is a view showing an operation button table stored in an operation button information storage unit shown in FIG. 1.

FIG. 6 is a flowchart showing an action procedure of the stencil printing machine when an initial setting process as an embodiment of the present invention is executed.

FIG. 7 is an image view showing a configuration of a work mode selection screen as an embodiment of the present invention.

FIG. 8 is a view showing a structure of data stored in a POP area registration information storage unit as an embodiment of the present invention.

FIG. 9 is a view showing a structure of data stored in a favorite area registration information storage unit as an embodiment of the present invention.

FIG. 10 is a flowchart showing an action procedure of the stencil printing machine when a start process as an embodiment of the present invention is executed.

FIG. 11 is a flowchart showing a subroutine of an initialization process shown in FIG. 10.

FIG. 12 is an image view showing a configuration of the POP area on the operation screen displayed on the display unit by the start process shown in FIG. 10.

FIG. 13 is an image view showing a configuration of the favorite area on the operation screen displayed on the display unit by the start process shown in FIG. 10.

### DETAILED DESCRIPTION OF THE PREFERRED EMBODIMENTS

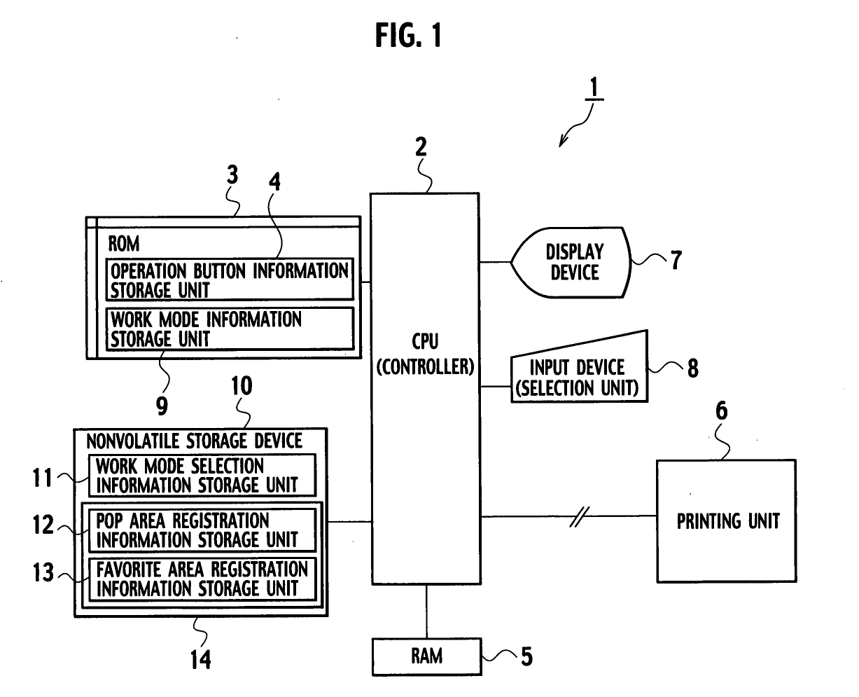

The present invention can be applied to a stencil printing machine with a configuration shown in FIG. 1. A description is given of the configuration and action of the stencil printing machine as an embodiment of the present invention in detail below with reference to the drawings.

First, the configuration of the stencil printing machine as an embodiment of the present invention is described with reference to FIG. 1.

FIG. 1 is a block diagram showing the configuration of the stencil printing machine as an embodiment of the present invention.

A stencil printing machine 1 as the embodiment of the present invention is configured as shown in FIG. 1 such that a CPU (central processing unit) 2 loads a control program stored in a ROM (read only memory) 3 into a RAM (random access memory) 5 and controls a printing unit 6 according to the loaded control program to control a series of processes of a stencil printing process including an image reading process, a stencil making process, and a printing process. The stencil printing machine 1 further includes a display device 7 such as a LCD (liquid crystal display) and an input device 8 such as a touch panel or a numeric keypad. A user can instruct the stencil printing machine 1 to execute various types of processes by selecting and operating operation buttons in an operation screen displayed on the display device 7 with the input device 8.

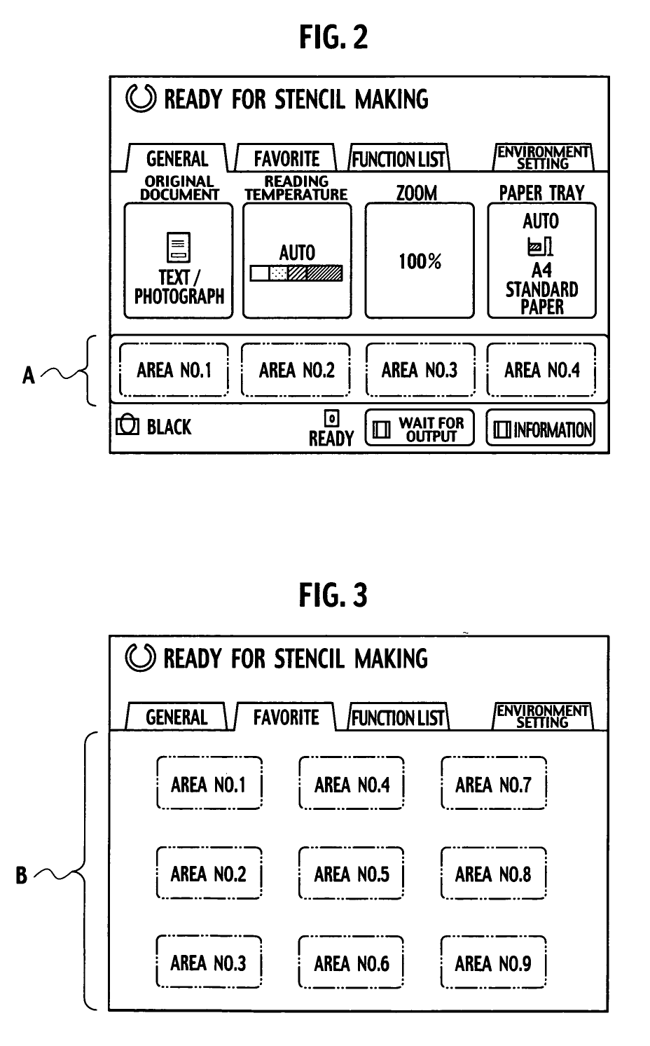

As shown in FIGS. 2 and 3, the operation screen displayed on the display device 7 includes a POP area A and a favorite area B, each of which includes a plurality of areas with specific area numbers assigned. In each area within the POP area A and favorite area B, an operation button most frequently used among the operation buttons for functions included in the stencil printing machine 1 is placed and displayed according to a work mode selected by the user, which is described in detail later. The above “operation buttons” mean operators assigned to the individual functions included in the stencil printing machine 1. In response to the user selecting and operating an operation button using the input device 8, the CPU 2 is instructed to execute a function assigned to the operation button selected and operated.

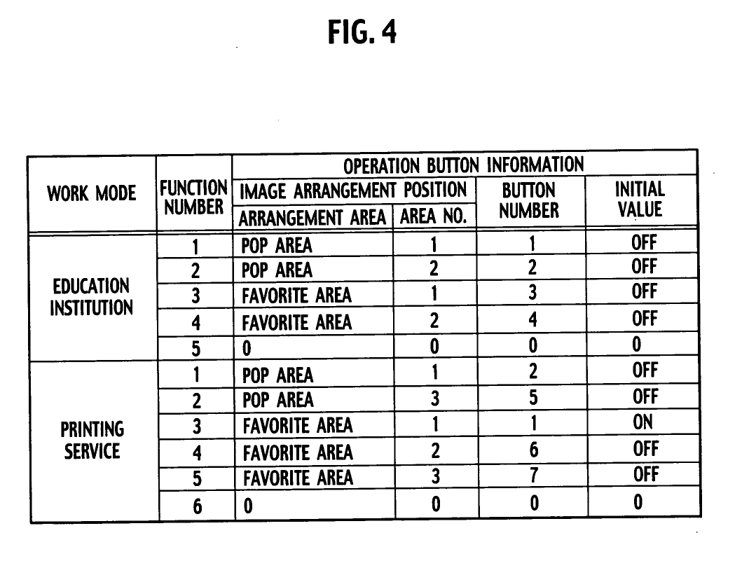

The stencil printing machine 1 includes a work mode table which defines frequently-used buttons of functions among the operation buttons for functions included in the stencil printing machine 1 for each of work modes previously set. The work mode table is previously stored in the ROM 3 as a work mode information storage unit 9. Specifically, the work mode table includes a structure shown in FIG. 4, in which a piece of operation button information with a function number assigned to is described for each of the work modes such as an educational institution and a printing service. The work mode table may be generated as below. For example, frequently-used operation buttons by a lot of users are checked preliminarily by way of experiment for each work mode, and the CPU 2 generates the work mode table based on information concerning the frequently-used buttons, which is related with button number. In addition, each user inputs each relation between an image arrangement position and operation button by using input device, and the CPU 2 generates the work mode table based on the inputted information. The operation button information includes an image arrangement position field, a button number field, and an initial value field. In the image arrangement position field, an area where the operation button is arranged and an area No. are described. In the button number field, the button number of the operation button is described. In the initial value field, an initial value of the operation button is described.

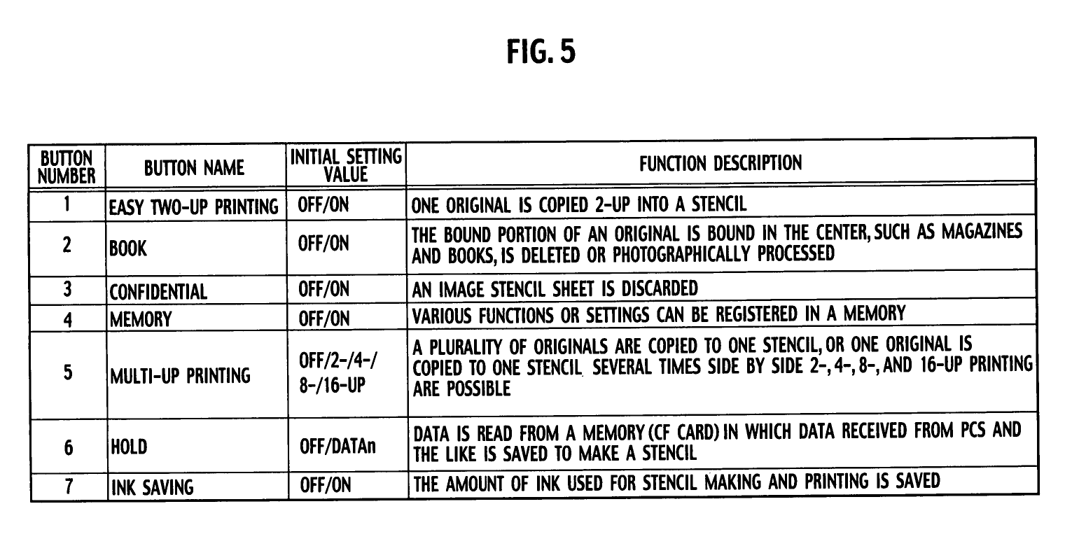

In this embodiment, the pieces of operation button information are registered in the work mode table sequentially from a function number of 1. “0” in the arrangement area field (for example, the arrangement area field corresponding to a function number of 5 when the work mode is “educational institution”) shows that the operation button information is not registered for that function number. When the arrangement area field of the function number of N is 0, the operation button information is not registered for the arrangement area fields of the function numbers of (N+1) or more. The stencil printing machine 1 includes an operation button table shown in FIG. 5 in which a button number, a button name, an initial setting value, and a function explanation of each button are described. The operation button table is previously stored in the ROM 3 as the operation button information storage unit 4. The CPU 2 executes the initial setting process and start process described later using these operation button table and work mode table.

The stencil printing machine 1 includes a nonvolatile storage unit 10 such as Flash-ROM and EEP-ROM (electronically erasable and programmable-ROM). This nonvolatile storage unit 10 includes a work mode selection information storage unit 11, a POP area registration information storage unit 12, and a favorite area registration information storage unit 13. The work mode selection information storage unit 11 stores information of the work mode selected by the user from among the work modes described in the work mode table. The POP area and favorite area registration information storage units 12 and 13 store information of operation buttons arranged in the POP area A and favorite area B, respectively, according to the work mode selected by the user. The POP area and favorite area registration information storage units 12 and 13 include button number fields and initial value fields corresponding to area Nos. of the plurality of arrangement areas provided in the POP area and favorite area, respectively. In each of the button number fields and each of initial value fields, the button number and the initial value of the operation button arranged in each arrangement area are described, respectively (see FIGS. 8 and 9).

In the stencil printing machine 1 including the aforementioned configuration, the CPU 2 executes the initial setting process and start process shown below to allow the configuration of the operation screen to be easily modified (customized) to a suitable configuration according to the work mode selected by the user. Hereinafter, the action procedure of the CPU 2 executing the initial setting process and start process is described in detail. The work mode selection information storage unit 11, input device 8, and CPU 2 function as a storage unit, a selection unit, and a controller according to the present invention, respectively. The POP area and favorite area registration information storage units 12 and 13 function as registration information storage units according to the present invention.

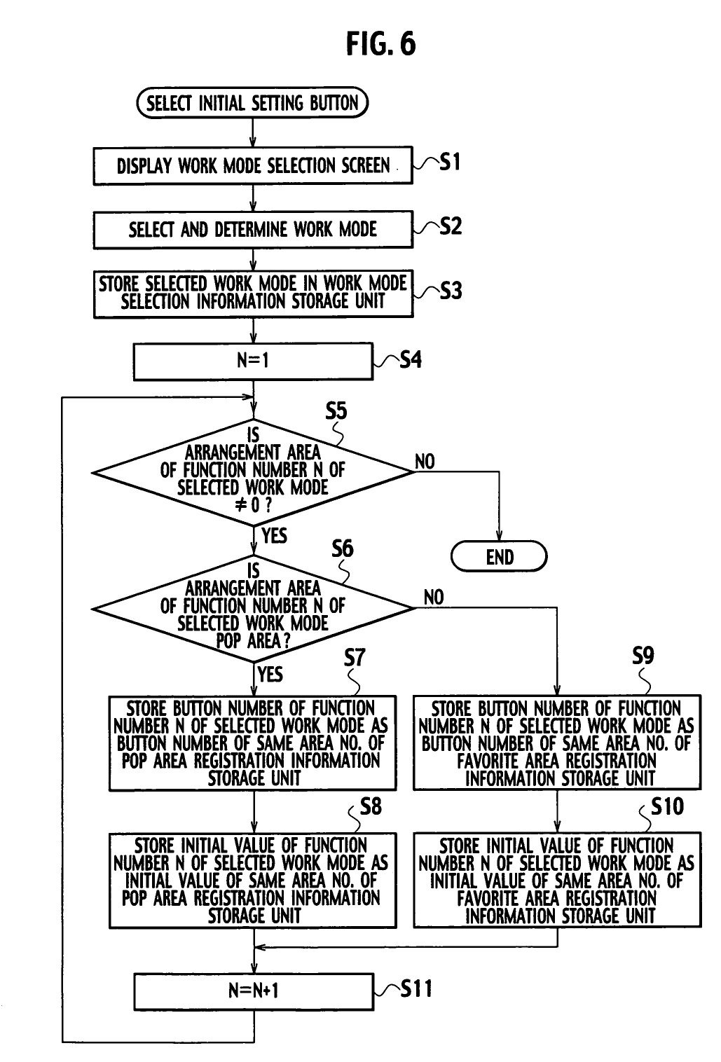

First, the action procedure of the CPU 2 executing the initial setting process is described with reference to a flowchart shown in FIG. 6.

The flowchart shown in FIG. 6 starts in response to the user operating the input device 8 and selecting an initial setting button, and the initial setting process proceeds to a process of step S1. In this embodiment, the initial setting process is started in response to the user selecting the initial setting button. However, to ensure that the user executes one or more process concerning the initial setting process shown below, this initial setting process may be started when the stencil printing machine 1 is activated at first.

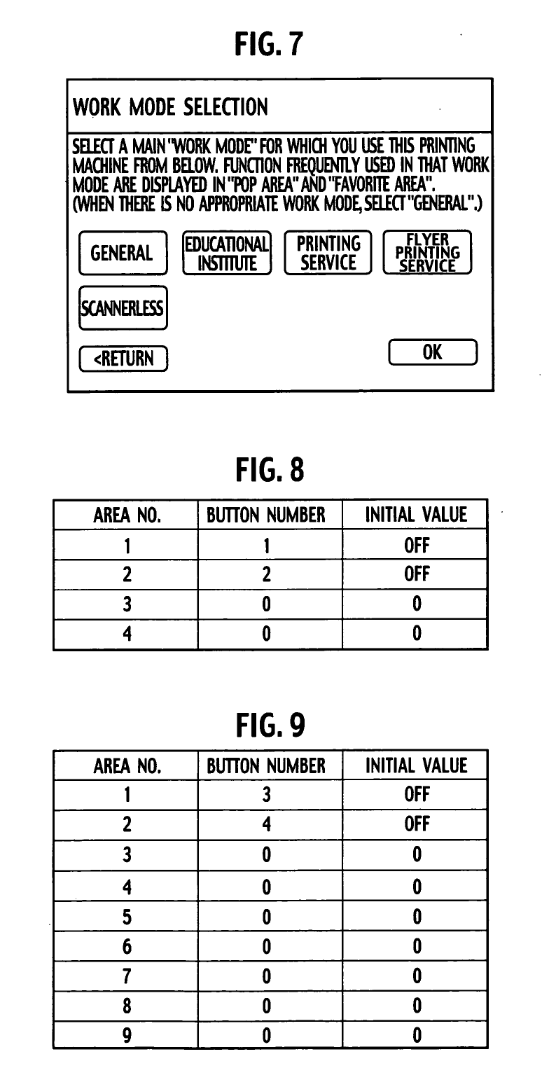

In the process of the step 1, the CPU 2 reads the work mode selection screen stored in the ROM 3 and displays the work mode selection screen on the display device 7 (see FIG. 7). The work mode selection screen is configured to allow the user to select a work mode in which the user mainly uses the stencil printing machine 1 from among work modes of general business, the educational institution, the printing service, a flyer printing service, and scannerless business.

In a process of the step S2, the user operates the input device 8 to select and determine a work mode mainly used on the work mode selection screen.

In a process of step 3, the CPU 2 stores the work mode selected by the user in the work mode selection information storage unit 11.

In a process of step 4, the CPU 2 sets a value N of a program counter for counting the function number of the work mode table to 1.

In a process of step 5, the CPU 2 retrieves the operation button information corresponding to the function number N of the work mode selected by the user with reference to the work mode table stored by the work mode information storage unit 9. The CPU 2 then determines whether the arrangement area field of the retrieved button information is 0. When the arrangement area field is “0” as a result of the determination, the CPU 2 determines that the operation button information is not registered for the function number N and terminates the series of processes of the initial setting process. On the other hand, when the arrangement area field is not “0”, the CPU 2 determines that the operation button information is registered for the function number of N and advances the initial setting process to a process of step S6.

In the process of the step S6, the CPU 2 determines with reference to the arrangement area field of the retrieved operation button information whether the POP area A is specified as the arrangement area. When the POP A is specified as the arrangement area, the CPU 2 advances the initial setting process to a process of step S7. On the other hand, when the favorite area B is specified as the arrangement area, the CPU 2 advances the initial setting process to a process of step S9.

In the process of the step S7, the CPU 2 reads the button number stored in the button number field of the retrieved operation button information and, as shown in FIG. 8, stores the read button number in a button number field corresponding to the area No. of the POP area registration information storage unit 12 which is the same as the area No. corresponding to the read button number stored in the image arrangement position field. The CPU 2 then advances the initial setting process to a process of step S8.

In the process of the step S8, the CPU 2 reads the initial value stored in the initial value field of the retrieved operation button information and, as shown in FIG. 8, stores the read initial value in the initial value field corresponding to the area No. of the POP area registration information storage unit 12 which is the same as the area No. corresponding to the read initial value stored in the image arrangement position field. The CPU 2 then advances the initial setting process to a process of step S11.

In the process of the step S9, the CPU 2 reads the button number stored in the button number field of the retrieved operation button information and, as shown in FIG. 9, stores the read button number in the button number field corresponding to the area No. of the favorite area registration information storage unit 13 which is the same as the area No. corresponding to the read button number stored in the image arrangement position field. The CPU 2 then advances the initial setting process to a process of step S10.

In the process of the step S10, the CPU 2 reads the initial value stored in the initial value field of the retrieved operation button information and, as shown in FIG. 9, stores the read initial value in the initial value field corresponding to the area No. of the favorite area registration information storage unit 13 which is the same as the area No. corresponding to the read initial value stored in the image arrangement position field. The CPU 2 then advances the initial setting process to the process of the step S11.

In the process of the step S11, the CPU 2 increments the value N of the program counter by 1 and then returns the initial setting process to the process of the step S5.

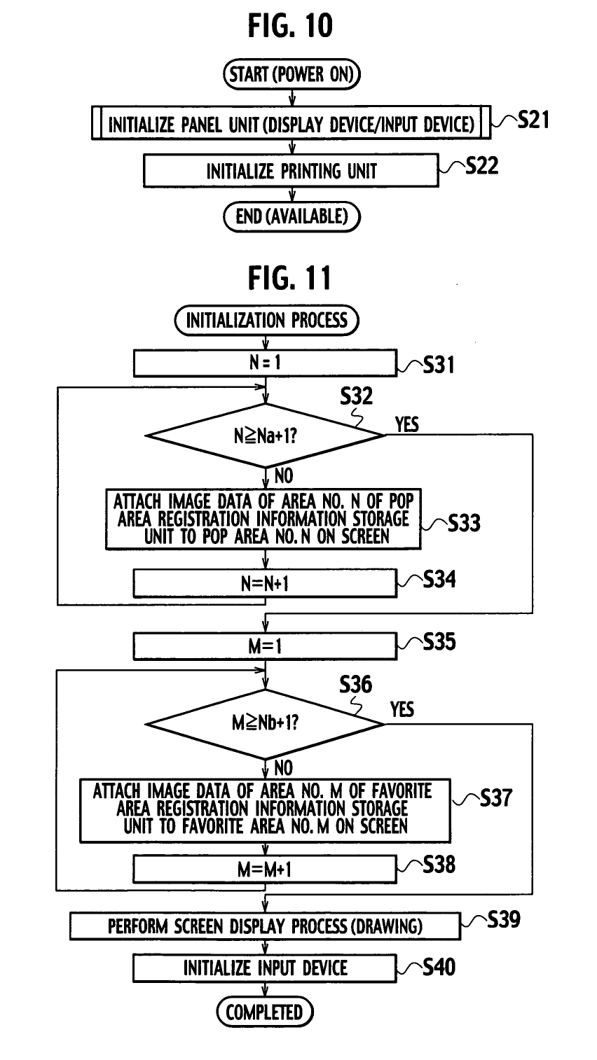

By the aforementioned initial setting process, in the POP area and favorite area registration information storage units 12 and 13, the operation buttons corresponding to the work mode selected by the user and the initial values thereof are registered as shown in FIGS. 8 and 9. When the operation buttons are registered in the POP area and favorite area registration information storage units 12 and 13 as described above, the CPU 2 executes the start process shown below to display the operation screen of a configuration suitable for the work mode selected by the user on the display device 7. The following description is given of an action procedure of the CPU 2 executing this start process with reference to flowcharts shown in FIGS. 10 and 11.

The flowchart shown in FIG. 10 starts in response to power to the stencil printing machine 1 being turned on and proceeds to a process of step S21.

In the process of the step S21, the CPU 2 initializes the display device 7 and input device 8. Details of the process of the step S21 are described later with reference to the flowchart shown FIG. 11.

In a process of step S22, the CPU 2 initializes the printing unit 6. The series of processes of the start process is terminated, and the stencil printing machine 1 becomes available.

The flowchart shown in FIG. 11 starts in response to the power to the stencil printing machine 1 being turned on and advances the initialization process to a process to step S31.

In the process of the step S31, the CPU 2 sets the value N of the program counter for counting the area number of the POP area A to 1.

In a process of step S32, the CPU 2 determines whether the value N of the program counter is equal to or greater than a number obtained by adding one to the total number Na of areas of the POP area A (in this embodiment, Na=4. See FIG. 2). When the value N of the program counter is not equal to or greater than the number obtained by adding one to the total number Na of areas of the POP area A as a result of the determination, the CPU 2 advances this initial setting process to step S35. On the other hand, when the value N of the program counter is less than the number obtained by adding one to the total number Na of areas of the POP area A, the CPU 2 advances this initial setting process to step S33.

In the process of the step S33, with reference to the operation button table, the CPU 2 attaches image data of the operation button corresponding to the button number stored in the button number field of the area No. N of the POP area registration information storage unit 12 to an area of the area No. of the operation screen corresponding to the area No. N of the POP area A.

In the process of the step S34, the CPU 2 adds 1 to the value N of the program counter and returns the initial setting process to the process of the step S32.

In the process of the step S35, the CPU 2 sets a value M of a program counter for counting the area No. of the favorite area B to 1.

In a process of step S36, the CPU 2 determines whether the value M of the program counter is equal to or greater than a number obtained by adding 1 to a total number Nb of areas of the favorite area B (in this embodiment, Nb=9, see FIG. 9). When the value M of the program counter is not equal to or greater than the number obtained by adding 1 to the total number Nb as a result of the determination, the CPU 2 advances the initial setting process to step S39. On the other hand, when the value M of the program counter is less than a number obtained by adding 1 to the total number Nb of areas of the favorite area B, the CPU 2 advances the initial setting process to step S37.

In the process of the step S37, with reference to the operation button table, the CPU 2 attaches image data of the operation button corresponding to the button number stored in the button number field of area No. M of the favorite area registration information storage unit 13 to an area of the area No. of the operation screen corresponding to the area No. M of the favorite area B.

Here, image data of the operation button corresponding to each button number may be stored in memory not shown in FIG. 1. Therefore, the CPU 2 can read the image data from the memory according to need.

In a process of step S38, the CPU 2 adds 1 to the value M of the program counter and returns the initial setting process to the process of the step S36.

In a process of step S39, the CPU 2 displays the operation screen on the display device 7 using image data of the operation screen after completion of the aforementioned processes. When displaying the operation screen, the CPU 2 launches functions of the operation buttons according to the initial values described in the initial value fields with reference to the initial value fields of the POP area and favorite area registration information storage units 12 and 13. Specifically, “ON” of the initial value of an arbitrary button number means that when an operation screen where a button of the button number is arranged is opened, a function of the button number is automatically launched. “OFF” of the initial value means that when the operation screen where the button of the button number is arranged is opened, the function thereof is not launched until the button number (actually, button) is clicked.

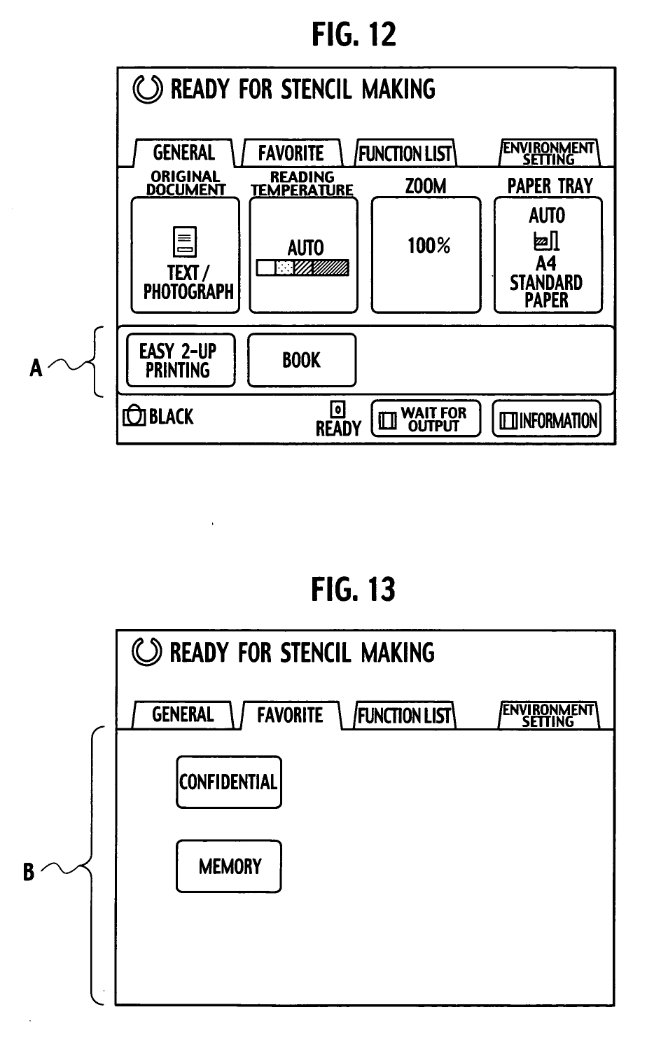

In a process of step S40, the CPU 2 initializes the input device 8. The series of processes of the initialization processes is then terminated. According to the above process, for example, when the user selects “educational institution” as the work mode, as shown in FIG. 12, operation buttons corresponding to functions of “easy 2-up printing” and “book” are displayed in areas of area Nos. 1 and 2 of the POP area A, respectively. As shown in FIG. 13, operation buttons corresponding to functions of “confidential” and “memory” are displayed in areas of area Nos. 1 and 2 of the favorite area B, respectively. In other words, the operation buttons corresponding to functions frequently used are displayed on the operation screen according to the work mode of the “educational institution” selected by the user.

As apparent from the aforementioned description, according to the stencil printing machine 1 as the embodiment of the present invention, the work mode table, which includes the information of operation buttons corresponding to functions frequently used according to the work modes, is previously stored in the work mode information storage unit 9. In response to the user operating the input device 8 to select the work mode, the CPU 2 retrieves the information of the operation buttons corresponding to the selected work mode from the work mode table and forms and displays the operation screen according to the retrieved information of the operation buttons. Accordingly, the user can easily modify the configuration of the operation screen to a configuration suitable for the work mode selected by the user.

According to the stencil printing machine 1 as the embodiment of the present invention, the information of the image arrangement position of each operation button on the operation screen is described in the work mode table. The CPU 2 lays out the operation buttons at the arrangement positions on the operation screen according to the retrieved information of the image arrangement positions of the operation buttons. Accordingly, the user can easily modify the configuration of the operation screen to a suitable configuration.

According to the stencil printing machine 1 as the embodiment of the present invention, the information of the initial values of the operation buttons is described in the work mode table. The CPU 2 launches the functions of the operation buttons according to the extracted information of the initial values of the operation buttons. Accordingly, the user can establish a printing environment more easily.

According to the stencil printing machine 1 as the embodiment of the present invention, the information of the operation buttons read from the work mode information storage unit 9 is stored in the POP area and favorite area registration information storage units 12 and 13. When the stencil printing machine 1 is activated, the CPU 2 displays the operation screen on the display device 7 according to the information stored in the POP area and favorite area registration information storage units 12 and 13. Accordingly, the user can always perform a printing work under a preferable printing environment once the initial setting process is executed.

The above description is given of the embodiment to which the present invention made by the inventor is applied, but the present invention is not limited by the description and drawings constituting a part of the disclosure of the present invention according to the embodiment. For example, in the aforementioned embodiment, the operation buttons displayed on the operation screen are classified depending on the work mode, but the present invention is not limited thereto. The operation buttons displayed in the operation screen can be classified into other groups, for example, classified according to whether the printing machine is for domestic use, classified by country or by area, classified by the kind of the machine, or classified by a combination thereof. Moreover, in the embodiment, the present invention is applied to the stencil printing machine, but the present invention can be applied to printing machines such as laser beam printers and ink-jet printers. At the end, it is obvious that other embodiments, examples, operational technologies, and the like made by those skilled in the art based on the aforementioned embodiment are within the scope of the present invention.

The entire content of a Patent Application No. TOKUGAN 2004-109281 with a filing date of Apr. 1, 2004, is hereby incorporated by reference.

1. A printing machine including a display unit on which an operation screen is displayed and capable of being instructed to execute a function assigned to an operation button on the operation screen by selection and operation of the operation button, comprising:
a storage unit storing information on the operation button arranged on the operation screen for each of a plurality of work modes;
a selection unit allowing a user to select a main work mode in which the printing machine is mainly used from among the plurality of work modes; and
a controller, in response to the main work mode being selected by the selection unit, reading information on the operation button corresponding to the main work mode from the storage unit, organizing the operation screen according to the information on the operation button, and displaying the operation screen organized on the display unit.

2. The printing machine according to claim 1, wherein
the information on the operation button includes information on a position at which the operation button on the operation screen is arranged, and the controller arranges the operation button on the operation screen according to the information on the position at which the operation button is arranged.

3. The printing machine according to claim 1, wherein
the information on the operation button includes information on an initial value of a function assigned to the operation button, and the controller launches the function of the operation button according to the information on the initial value.

4. The printing machine according to claim 1, further comprising:
a registration information storage unit storing the information on the operation button read from the storage unit, wherein
when the printing machine is activated, the controller organizes and displays the operation screen according to the information on the operation button of the registration information storage unit.

5. A method of controlling a printing machine including a display unit on which an operation screen is displayed and capable of being instructed to execute a function assigned to an operation button on the operation screen by selection and operation of the operation button, the method comprising the steps of:
a user selecting a main work mode in which the printing machine is mainly used from among a plurality of work modes; and
in response to the user selecting the main work mode, reading information on the operation button corresponding to the main work mode from a storage unit which stores information on the operation button arranged on the operation screen for each of a plurality of work modes, organizing the operation screen according to the information on the operation button, and displaying the operation screen on the display unit.
